(19) United States
(12) Patent Application Publication
(10) Pub. No.: US 2012/0048088 A1
(43) Pub. Date: Mar. 1, 2012

(54) CUTTING DEVICE FOR ROLLS OF RIBBON-LIKE MATERIAL, IN PARTICULAR A PAPER MATERIAL

(75) Inventor: Giovanni Gambini, Pisa (IT)

(73) Assignee: GAMBINI INTERNATIONAL S.A., Luxembourg (LU)

(21) Appl. No.: 13/218,064

(22) Filed: Aug. 25, 2011

(30) Foreign Application Priority Data
Aug. 27, 2010 (IT) MI2010A 001580

(51) Int. Cl. B26D 1/547

(52) U.S. Cl. 83/307.1

(57) ABSTRACT

The present invention concerns a cutting device for rolls of ribbon-like material. The device 1 comprises cutting means active on at least one roll in order to divide this latter in two or more pieces. The cutting means are commutable between a non operative condition, in which they do not act on the roll, and an operative condition, in which they transversally cut the roll. The cutting means comprise a thread-like cutting element which develops transversally to the roll. The cutting thread is mobile along its longitudinal development so as to cut the roll. The cutting means comprise at least one handling member, preferably two pulleys operatively associated to the thread-like cutting element to move this latter along its longitudinal development.

### CROSS-REFERENCE TO RELATED APPLICATIONS

This Application claims the benefit of priority from Italian Patent Application No. MI2010A 001580 filed on Aug. 27, 2010, the contents of which are incorporated herein by reference.

### FIELD OF THE INVENTION

The present invention refers to a cutting device for rolls of ribbon-like material, in particular a paper material.

The object of the present invention is suitable for being used in the industrial field of machines and devices intended to make rolls of “tissue” paper, like for example toilet paper, kitchen roll paper and/or the like.

In detail, the present invention is one of those devices intended to cut long rolls of ribbon-like material in two or more pieces each having a predetermined length and each corresponding to an end product to be packaged.

### BACKGROUND OF THE INVENTION

As it is known, there are many cutting devices suitable for transversally cutting long rolls of ribbon-like material into a series of pieces or rolls of shorter lengths, according to configurations that are in accordance with the standards currently in use.

Generally, the cutting of the aforementioned rolls is carried out by means of suitable circular cutting blades that transversally intercept the rolls along a horizontal or vertical cutting direction.

Circular blades are usually operatively arranged along a path along which the rolls proceed so that the interception of the latter occurs through the advancing movement of the rolls towards the circular cutting blades.

Alternatively, the circular cutting blades can be mobile between a non operative condition, in which they are spaced apart from the path along which the rolls proceed, and an operative condition, in which they are arranged along the path of advancing movement so as to intercept the rolls to be cut.

Known cutting devices can also provide cutting blades that are suitably located along the path along which the rolls proceed so as to intercept and cut the rolls being supplied into a series of shorter pieces.

In order to increase the cutting action of the cutting blades, these latter are made in a way such as to have respective cutting edges provided with suitable teeth.

Although the aforementioned cutting devices make it possible to cut the rolls in shorter pieces in a satisfactory manner, the Applicant has found that these do however have some drawbacks and can be improved in many aspects, mainly related to the continuous and constant sharpening of the cutting blades that is necessary during their operation, to the undesired production of sparks and slag and/or metal powder, as well as to the considerable dimensions and bulk of the cutting blades and of the members associated to them.

In particular, the Applicant has found that, in order to ensure the correct operation of the cutting blades and to ensure a satisfactory cutting of the aforementioned rolls, a sharpening device is operatively associated to the cutting blades, said sharpening device remaining always active so as to continuously sharpen the blades.

The continuous action of the sharpening device on the cutting blades, leads to an undesired production of sparks which can lead to inconvenient situations of danger related to the high flammability of the materials transported by the rolls.

The continuous sharpening of the cutting blades also produces high quantities of powders and/or slag which, in the case in which the materials are intended for the field of hygienic and sanitary, can jeopardise the products during their manufacture. The production of such slag therefore requires, on one hand, consequent and continuous maintenance operations, the costs of which negatively affect the overall production and/or commercialization costs of the end products and, on the other hand, the provision of complex and expensive systems for intercepting and collecting the slag produced during the operation of the cutting blades.

It should also be considered that the aforementioned cutting blades and the handling members associated to them have dimensions and bulk that are particularly large, which make the cutting operations of the roll more complex.

Of course, also the complexity of the handling members of the cutting blades contributes towards the increase in production and commercialization costs of the products to be packaged.

In addition, it has been found that, cutting blades with a great thickness like those described above tend to damage the structure of the pieces obtained, the structure of which does not take up a compact configuration like that which is desired.

### SUMMARY OF THE INVENTION

The main purpose of the present invention is to provide a cutting device for rolls of ribbon-like material, in particular a paper material, that is capable of overcoming the drawbacks found in the prior art.

A further purpose of the present invention is to propose a cutting device that is capable of ensuring a considerable number of cutting cycles without requiring the aid of sharpening members, devices or systems.

Another purpose of the present invention is to provide a cutting device which does not produce sparks or slag or other similar polluting powders, during its operation.

A further purpose of the present invention is to propose a cutting device having overall small dimensions.

Yet another purpose of the present invention is to provide a cutting device which makes it possible to cut down the overall production and/or commercialization costs of the pieces of the rolls to be packaged.

The purposes specified above, and others, are substantially achieved by a device for cutting rolls of ribbon-like material, in particular a paper material, as expressed and described in the following claims.

### BRIEF DESCRIPTION OF THE DRAWINGS

It is provided, as an example, the description of a preferred, but not exclusive, embodiment of a cutting device for rolls of ribbon-like material, in particular a paper material, in accordance with the present invention. Such a description shall be made hereafter with reference to the attached drawings, provided purely for indicating and therefore not limiting purposes, in which:

FIG. 1 is a schematic perspective representation of a cutting device for rolls in ribbon-like material, in particular a paper material, in accordance with a first embodiment of the present invention;

FIG. 2 is a side schematic representation of the device according to FIG. 1;

FIG. 3 is a side schematic representation of a cutting device, in accordance with a second embodiment of the present invention;

FIG. 4 is a side schematic representation of a cutting device, in accordance with a third embodiment of the present invention;

FIG. 5 is a side schematic representation of a cutting device, in accordance with a fourth embodiment of the present invention;

FIG. 6 is a side schematic representation of a cutting device, in accordance with a fifth embodiment of the present invention;

FIG. 7 is a side schematic representation of a cutting device, in accordance with a sixth embodiment of the present invention;

FIG. 8 is a side schematic representation of a cutting device, in accordance with a seventh embodiment of the present invention;

FIG. 9 is a side schematic representation of a cutting device, in accordance with an eighth embodiment of the present invention;

FIG. 10 is a front schematic representation of a cutting device, in accordance with a ninth embodiment of the present invention;

FIG. 11 is a schematic perspective representation of the device according to FIG. 10;

FIG. 12 is a front schematic representation of a cutting device, in accordance with a tenth embodiment of the present invention;

FIG. 13 is a top schematic representation of a cutting device, in accordance with an eleventh embodiment of the present invention; and

FIG. 14 is a front schematic representation of a cutting device, in accordance with a twelfth embodiment of the present invention.

### DETAILED DESCRIPTION OF THE INVENTION

With reference to the attached figures, reference numeral 1 wholly indicates a cutting device for rolls of ribbon-like material, in particular a paper material, in accordance with the present invention.

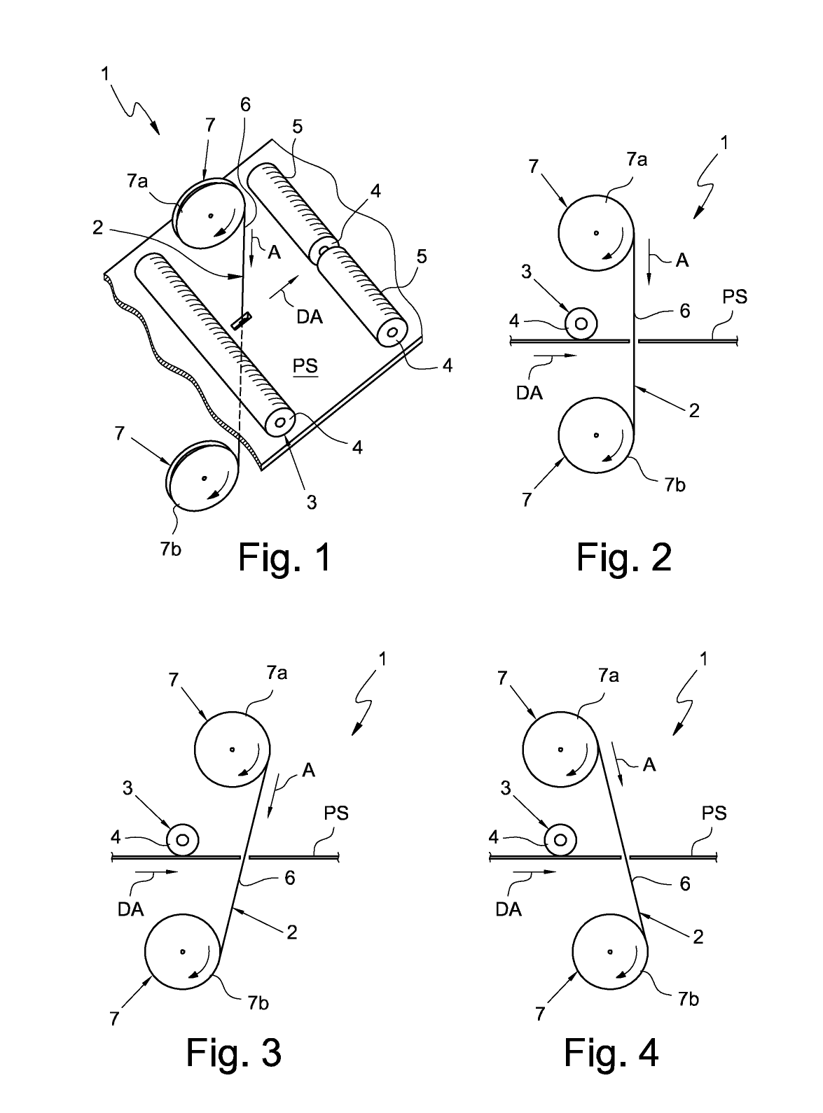

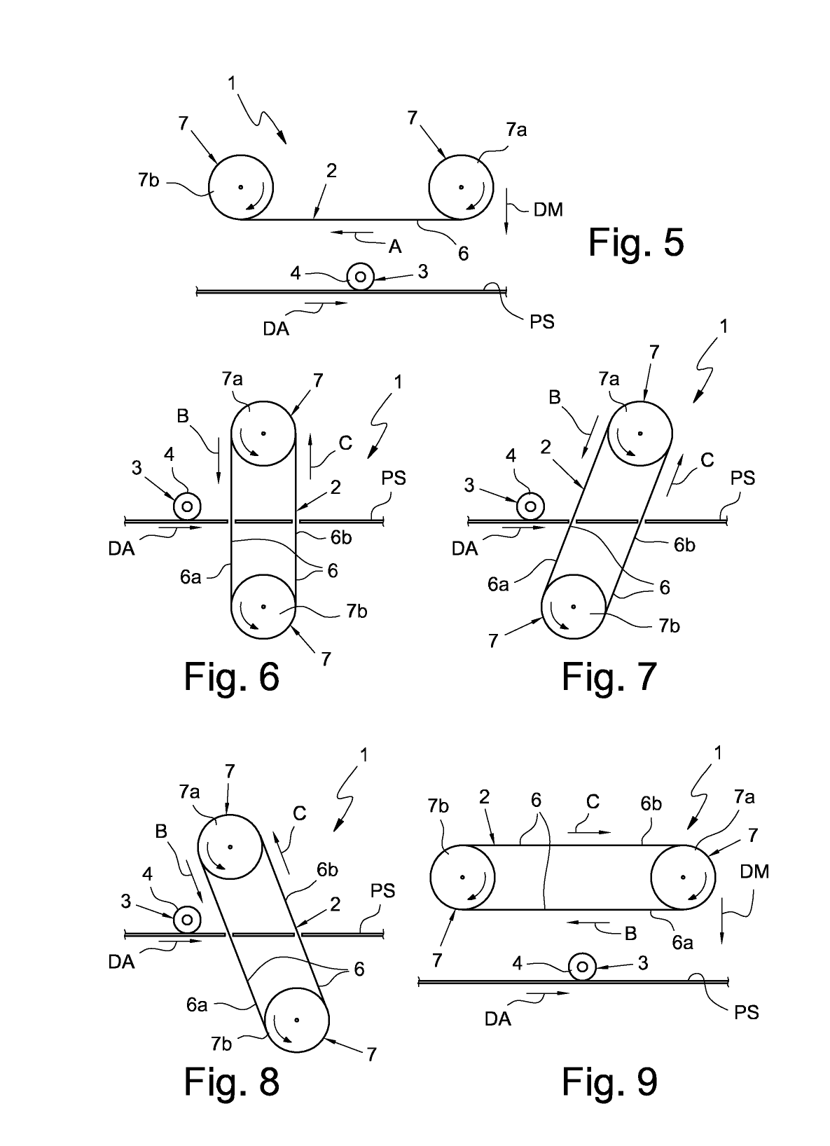

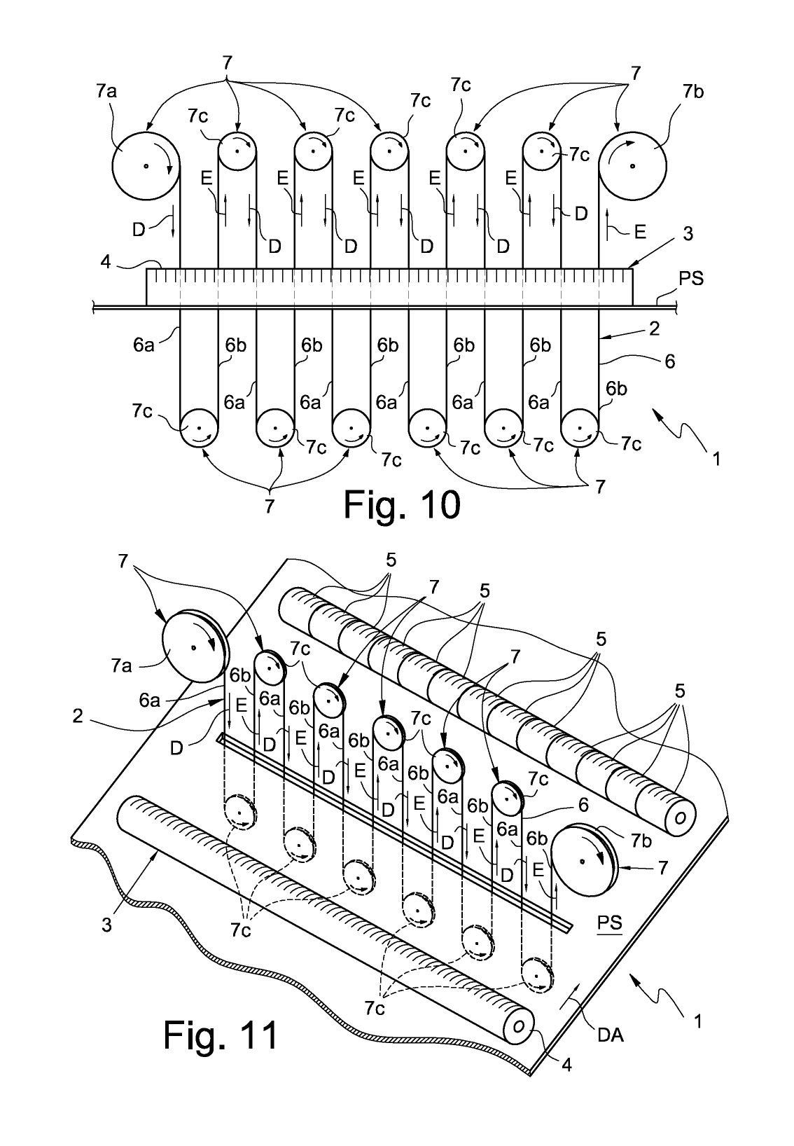

As visible in the attached figures, the device 1 comprises cutting means 2 active on at least one roll 3 of ribbon-like material 4 in order to divide this latter in at least two pieces 5 each having a predetermined length. The cutting means 2 are commutable between a non operative condition, in which they do not act upon the roll 3, and an operative condition, in which they transversally intercept the roll 3 being supplied so as to cut it as represented in FIGS. 1, 11 and 13.

The device 1 further comprises handling means (which are not illustrated since they are of the known type) for relatively moving the roll 3 being supplied and the cutting means 2, between a first position, in which the cutting means 2 are spaced apart from the roll 3 and a second position, in which the cutting means 2 intercept the roll 3 so as to cut it.

The handling means can provide any known handling system or member that is capable of moving the rolls 3 to be cut with respect to the cutting means 2, or move the cutting means 2 with respect to the rolls 3 to be cut, or yet, simultaneously move the rolls 3 and the cutting means 2 towards each other.

Advantageously, as illustrated in the attached figures, the cutting means 2 comprise at least one, substantially thread-like cutting element 6 which develops longitudinally and transversally to the longitudinal development of the roll 3.

It should be specified that with the term thread-like it is meant a structure that has one dimension which is greater than the others. Therefore, even a structure substantially shaped like a cord or having a shape that is similar to the thread-like configuration, is capable of carrying out the same tasks as the thread-like cutting element described and illustrated.

The thread-like cutting element 6 is mobile along its longitudinal development, at least when the cutting means 2 are commutated in operative condition, so that, when the handling means are in the second position the thread-like cutting element 6 cuts the roll 3 in at least two pieces 5 each having a predetermined length.

Advantageously, the cutting means 2 comprise at least one handling member 7 that is operatively associated to the thread-like cutting element 6 so as to move this latter along its longitudinal development.

In accordance with the embodiments illustrated in figures from 1 to 5, 10, 11 and 13, the handling member 7 comprises a first pulley 7a from which the thread-like cutting element 6 is unwound, during the operation of the cutting means 2, and a second pulley 7b, on which the thread-like cutting element 6 is wound.

According to such a solution, the thread-like cutting element 6 is transferred from the first pulley 7a to the second pulley 7b according to a preferred direction of advancing movement A. When the thread-like cutting element 6 is completely unwound from the first pulley 7a and is completely wound on the second pulley 7b, it is possible to quickly rewind the thread-like cutting element 6 onto the first pulley 7a so as to reactivate the movement thereof according to the initial direction of movement A, or so as to reverse the rotation of the pulleys 7a, 7b so as to determine the transfer of the thread-like cutting element 6 from the second pulley 7b to the first pulley 7a according to one direction of movement that is opposite to the initial direction of movement A.

With particular reference to the embodiment illustrated in FIGS. 1 and 2, the thread-like cutting element 6 substantially develops perpendicularly to the roll 3 to be cut and to a sliding plane PS of the latter which defines a respective direction of advancing movement DA thereof, which is substantially rectilinear. In such a case, the preferred direction of movement A of the thread-like cutting element 6 is directed perpendicularly with respect to the sliding plane PS, from top to bottom.

In accordance with the embodiments represented in FIGS. 3 and 4, the thread-like cutting element 6 substantially develops perpendicularly to the roll 3 to be cut and obliquely to the sliding plane PS and to the direction of advancing movement DA of the roll itself.

The embodiments represented in figures from 1 to 4, provide a static position of the cutting means 2, towards which, the rolls 3 proceed along the direction of advancing movement DA until they intercept the respective thread-like cutting element 6.

Of course, for the purposes of the present invention, the cutting means 2 can also be suitably moved towards the rolls 3 in advancement along the sliding plane PS.

In accordance with the embodiment illustrated in FIG. 10, the thread-like cutting element 6 substantially develops perpendicularly with respect to the roll 3 to be cut and substantially parallel to the sliding plane PS and to the direction of advancing movement DA of the roll itself. In this case, the preferred direction of movement A of the thread-like cutting element 6 is directed parallel with respect to the sliding plane PS from right to left, that is to say in a direction that is opposite to the direction of advancing movement DA of the rolls 3.

In order to allow the roll 3 to be cut, the cutting means 2 are commutated from the non operative condition, in which the thread-like cutting element 6 is above the roll 3, to an operative condition, in which the thread-like cutting element 6 intercepts the roll 3 sliding on the plane PS, according to a direction of movement DM from top to bottom.

In accordance with the embodiments represented in figures from 6 to 9 and 12, the handling member comprises a first and a second pulley 7a, 7b on which the thread-like cutting element 6, is partially wound so that this latter can be actuated according to a continuous movement modality.

In accordance with the embodiments represented in figures from 6 to 9, the thread-like cutting element 6 develops according to a closed path, in particular a ring-shaped path.

As visible in figures from 6 to 9, a first branch 6a of the thread-like cutting element 6, interposed between the pulleys 7a, 7b, proceeds along a first direction of movement B, whereas a second branch 6b of the thread-like cutting element 6, also interposed between the first and the second pulley 7a, 7b and substantially parallel to the first branch 6a, proceeds along a second direction of movement C opposed to the first direction of movement B.

In accordance with the embodiment represented in FIG. 6, the branches 6a, 6b of the thread-like cutting element 6 extend longitudinally substantially perpendicular with respect to the roll 3 to be cut, to the sliding plane PS and to the direction of advancing movement DA of the roll itself.

In accordance with the embodiments illustrated in FIGS. 7 and 8, the branches 6a, 6b of the thread-like cutting element 6 extend longitudinally substantially perpendicular with respect to the rolls 3 to be cut and obliquely with respect to the sliding plane PS and to the direction of advancing movement DA of the latter.

Preferably, the embodiments illustrated in figures from 6 to 8, provide that the direction of movement B of the first branch 6a, is directed from top to bottom, whereas the direction of movement C of the second branch 7b is directed from bottom to top.

In accordance with the embodiment represented in FIG. 9, the branches 6a, 6b of the thread-like cutting element 6 extend longitudinally substantially perpendicular with respect to the rolls 3 to be cut and substantially parallel to the sliding plane PS and to the direction of advancing movement DA of the latter.

Even in this case, it is preferable for the cutting means 2 to be commutated from the non operative condition, in which the thread-like cutting element 6 is above the roll 3, to an operative condition, in which at least the first branch 6a of the thread-like cutting element 6, according to a direction of movement DM from top to bottom, intercepts the roll 3 sliding on the plane PS.

In accordance with the embodiments represented in figures from 10 to 13, the handling member 7 further comprises a plurality of auxiliary pulleys 7c operatively interposed between the first and the second pulley 7a, 7b.

As visible in figures from 10 to 13, the auxiliary pulleys 7c are arranged according to an alternate configuration and are partially wound by the thread-like cutting element 6 in order to define a plurality of first branches 6a able to proceed along a first direction of movement D, and a plurality of second branches 6b, substantially parallel to the first branches 6a, able to proceed along a second direction of movement E opposed to the first one D.

In accordance with the embodiment illustrated in FIGS. 10 and 11, the branches 6a, 6b of the cutting thread 6 are substantially oriented perpendicularly with respect to the rolls 3 being supplied and to the sliding plane PS and to the direction of advancing movement DA of the latter. In this case, the first direction of movement D of each first branch 6a, defines a direction of advancing movement of the thread-like cutting element 6, oriented from top to bottom, substantially perpendicular to the sliding plane PS, whereas the second direction of movement E, defines a direction of advancing movement of the thread-like cutting element 6, oriented from bottom to top, substantially perpendicularly to the sliding plane PS.

Of course the embodiment illustrated in FIGS. 10 and 11 can also provide the inclination of the branches 6a, 6b of the thread-like cutting element 6 with respect to the sliding plane PS.

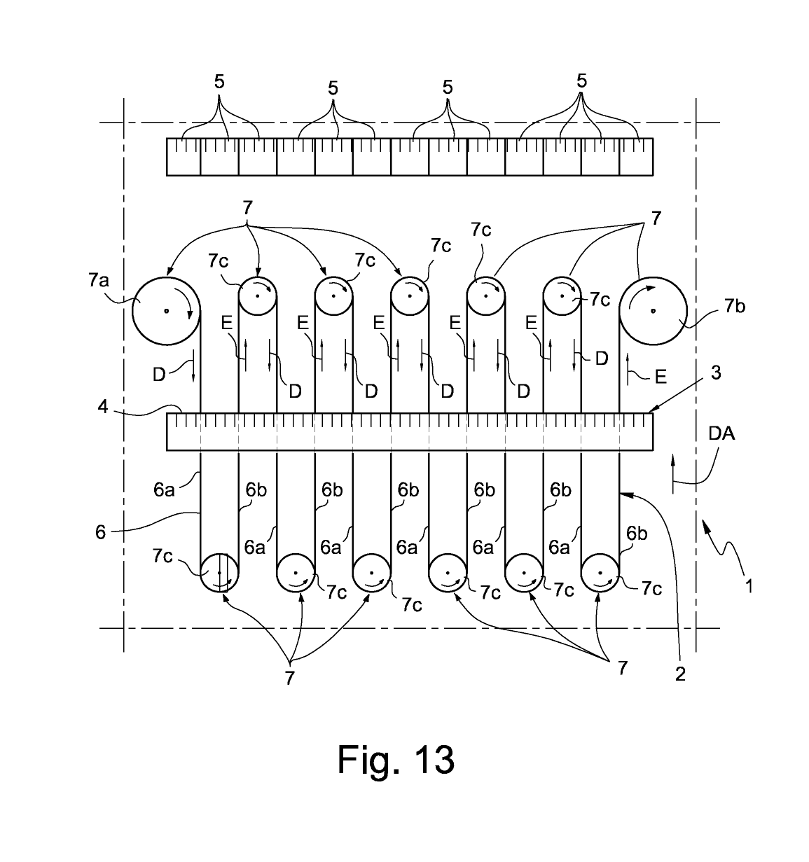

In accordance with the embodiment represented in FIG. 13, the cutting device 1 is almost identical to the cutting device of the embodiment represented in FIGS. 10 and 11. In this case, the branches 6a, 6b of the thread-like cutting element 6 are oriented substantially perpendicularly with respect to the rolls 3 being supplied and substantially parallel to the sliding plane PS and to the direction of advancing movement DA of the latter.

In accordance with such a solution, the first direction of movement D of each first branch 6a, defines a direction of the thread-like cutting element 6, that is opposite to the direction of advancing movement DA of the rolls 3, whereas the second direction of movement E, defines a direction of advancing movement of the thread-like cutting element 6 that is in concordance with the direction of advancement DA of the rolls 3.

Of course, the cutting must be carried out through commutation of the cutting means 2 from the non operative condition to the operative condition.

In detail, the thread-like cutting element 6 must be lowered until it intercepts and cuts the roll 3 arranged on the sliding plane PS.

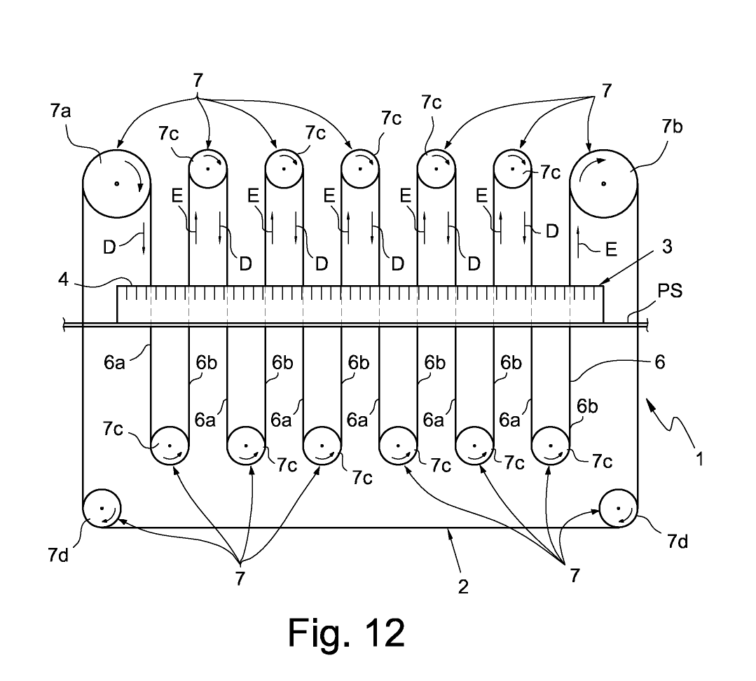

In accordance with the embodiment represented in FIG. 12, the cutting device 1 is quite similar to the cutting device 1 illustrated in FIGS. 10 and 11.

Contrarily to such an embodiment, the handling member comprises additional counter-pulleys 7d also partially wound by the thread-like cutting element 6, which extends according to a closed path so that the movement of the latter can be carried out continuously without winding back up again or reversing the direction of the movement.

Of course such a solution can be applied also to the device 1 illustrated in FIG. 13.

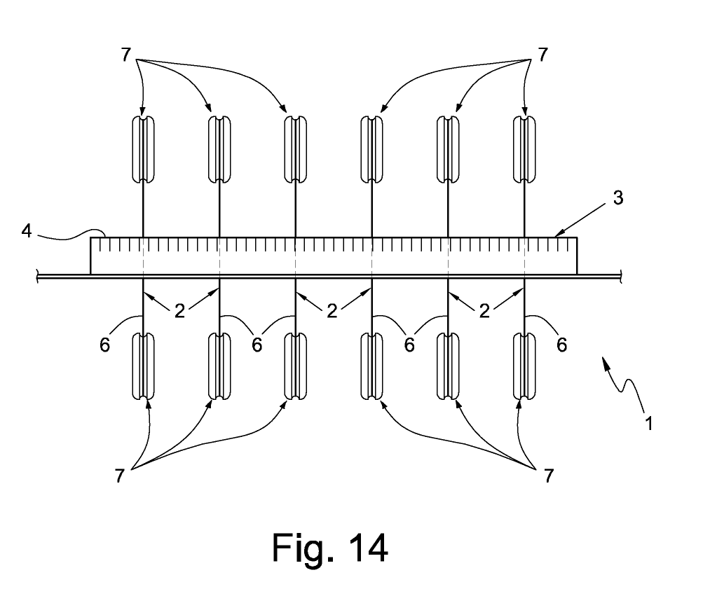

In accordance with the set-up represented in FIG. 14, in such an embodiment cutting means 2 are provided comprising a plurality of thread-like cutting elements 6 which develop, substantially parallel one near the other, transversally with respect to the longitudinal development of the rolls 3 being supplied.

In accordance with such a solution, each thread-like cutting element 6 is mobile along its longitudinal development when the cutting means 2 are commutated in operative condition, that is to say, when the handling means are in the second position. In this position, the thread-like cutting elements 6 cut the roll 3 in a series of pieces 5 each having a predetermined length.

Again with reference to such an embodiment, the cutting means 2 comprise a plurality of handling members 7 each operatively associated to a respective thread-like cutting element 6 to move this latter along its longitudinal development.

The handling members 7 can be identical to the handling members 7 represented in figures from 1 to 5 or be identical to the handling members 7 represented in figures from 6 to 9.

The device in accordance with the present invention overcomes the drawbacks found in the prior art and achieves important advantages.

Firstly, the aforementioned device ensures the optimal cutting of the rolls being supplied without requiring continuous sharpening devices, members or systems.

It should therefore be considered that the described cutting device ensures that the rolls are cut both without the production of sparks and without the production of metal slag.

The elimination of the sparks makes the device particularly safe.

The elimination of the metal slag makes it possible, on one hand, to hygienically protect the products being produced and, on the other hand, makes it possible to eliminate the costly and complex systems for intercepting these.

It should also be considered that the device thus conceived allows a significant reduction in the production and/or commercialization costs of the rolls.

1. A cutting device for rolls of ribbon-like material, in particular a paper material, comprising:
cutting means active on at least a roll of ribbon-like material in order to divide this latter in at least two pieces each having a predetermined length, said cutting means being commutable between a non operative condition, in which they do not act on said roll, and an operative condition, in which they transversally cut said roll; and
handling means for relatively moving said roll and said cutting means between a first position, in which said cutting means are spaced from said roll and a second position, in which said cutting means intercept said roll in order to cut this latter,
wherein said cutting means comprise:
at least a substantially thread-like cutting element, developed longitudinally and transversally to the longitudinal development of said roll, said thread-like cutting element being movable along its longitudinal development at least when said cutting means are commutated in an operative condition, whereby when said handling means are in a second position, said thread-like cutting element cuts said roll in at least two pieces each having a predetermined length; and
at least a handling member operatively associated to said thread-like cutting element in order to move this latter along its longitudinal development.

2. The device according to claim 1, wherein said handling member comprises:
a first pulley from which said thread-like cutting element is unwound; and
a second pulley on which said cutting thread is wound.

3. The device according to claim 1, wherein said handling member comprises:
a first pulley on which said thread-like cutting element is partially wound; and
a second pulley on which said thread-like cutting element is partially wound, said thread-like cutting element developing according to a closed path, in particular ring-shaped, whereby a first branch of said thread-like cutting element, interposed between said pulleys proceeds along a first direction (B) of movement and a second branch of said thread-like cutting element, also interposed between the first and second pulley and substantially parallel to the first branch, advances along a second direction (C) of movement opposed to the first direction (B).

4. The device according to claim 3, wherein said handling member further comprises a plurality of auxiliary pulleys operatively interposed between said first and second pulley, said auxiliary pulleys being placed according to an alternate configuration and being partially wound by said thread-like cutting element in order to define a plurality of first branches able to proceed along a first direction of movement, and a plurality of second branches, substantially parallel to first branches, able to proceed along a second direction (E) of movement opposed to the first one.

5. The device according to claim 1, wherein said cutting means comprise:
a plurality of thread-like cutting elements developing one near to the other, longitudinally and transversally to the longitudinal development of said roll and substantially parallel each other, said thread-like cutting elements being each movable along its own longitudinal development at least when said cutting means are commutated in an operative condition, whereby when said handling means are in the second position, said thread-like cutting elements cut said roll in at least two pieces each having a predetermined length; and
a plurality of handling members each operatively associated to a respective thread-like cutting element in order to move this latter along its own longitudinal development.

6. The device according to claim 1, in which each thread-like cutting element substantially develops transversally.

7. The device according to claim 5, in which each thread-like cutting element substantially develops in parallel to the relative handling direction (DA), defined and actuated by said handling means.

8. The device according to claim 5, in which each thread-like cutting element develops obliquely to the relative handling direction (DA), defined and actuated by said handling means.

9. The device according to claim 6, in which each thread-like cutting element substantially develops perpendicularly to the relative handling direction (DA), defined and actuated by said handling means.
